(19) United States
(12) Patent Application Publication
(10) Pub. No.: US 2010/0211004 A1
(43) Pub. Date: Aug. 19, 2010

(54) MEDICINE CUP COMBINED WITH GAUGE FOR CHECKING RISK OF OBJECTS CAUSING A BABY TO CHOKE

(76) Inventors: Keely Williams, Ipswich (GB); Irene Dorothy Archer, Ipswich Road (GB)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/445,834

(22) PCT Filed: Oct. 23, 2007
(86) PCT No.: PCT/GB07/04058

§ 371 Date: Apr. 16, 2009

(30) Foreign Application Priority Data
Oct. 27, 2006 (GB) 0621509.9

(51) Int. Cl. A61J 7/00

(52) U.S. Cl. 604/78

(57) ABSTRACT

A babycare device combines in one piece a medicine cup (10) and a choking hazard checking unit (16). The cup and the checking unit are formed in one piece, with the checking unit forming a stem for the cup, and the cup forming a base for the checking unit, with a neck (14) therebetween. The device may be a transparent plastics moulding with graduations on the wall of the cup. The (unit 16) may be a hollow cylindrical tube with an inclined inner floor (20) and of a size corresponding to dimensions of a baby's throat, so as to serve as a gauge to assess risk of choking by attempting to insert objects into it.

This invention relates to a dual function device useful for those caring for babies.

According to the invention there is provided a babycare device comprising a medicine cup mounted on a stem, wherein the stem is constructed in the form of a gauge for checking whether an object is of a shape and size liable to cause a bay to choke.

In this specification, such a gauge may be referred to as a choking hazard checking section or unit.

Babies are at risk if they swallow small objects which can lodge in their throat and cause choking. Toy manufacturers are required to print warnings on products which contain parts below a certain size, to warn parents that those products are not safe for use by/with babies and small children, and manufacturers are equipped to test their products to decide whether or not the appropriate warning has to be placed. However there are many small items in the home which could potentially be played with by babies and which, if a baby puts it in its mouth, could result in choking. It is therefore desirable for parents to be able to check whether or not an item is or is not too small to allow it to be played with by a baby. The availability of a choking hazard checking unit which can be used in the home is therefore advantageous.

It is also advantageous if the device has a neck between the cup and the stem. This enables the device to be more easily and securely gripped with one hand when administering medicine to a baby who may be wriggling as the medicine is being administered.

The device is preferably made as a single plastics moulding, and the walls of the device can be transparent or at least translucent. Graduations can be applied to the walls of the medicine cup.

The invention will now be further described, by way of example, with reference to the accompanying drawings, in which:

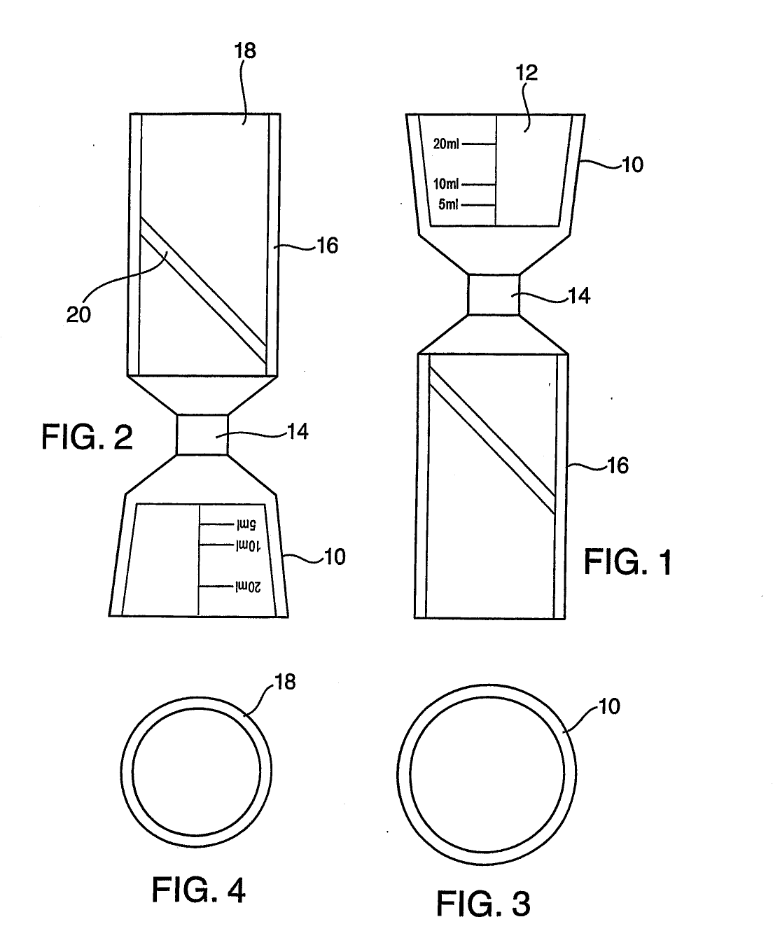

FIG. 1 is a side view of the device of the invention, with the medicine cup
uppermost;

FIG. 2 is another side view of the device, with the choking hazard
checking section uppermost;

FIG. 3 is a plan view on the medicine cup end; and

FIG. 4 is a plan view on the choking hazard checking section end.

The device shown is intended to be moulded in a single piece, although design modifications may be made to enable moulding to take place. Alternatively, the device may be made up from separately moulded components which are then fixed together, probably permanently but possibly separable.

At the top (FIG. 1) the device has a cup 10 with graduations 12 on the side. The graduations can be printed onto the device, or moulded in. They will indicate quantities of liquid medicine, in any desired system of units, eg in standard spoons or in millilitres.

Below the cup is a relatively narrow neck 14 which connects the upper and lower parts of the device. The bottom part of the device, which forms a stand for the cup 10 in the position shown in FIG. 1, is a choking hazard checking section 16. When the cup is being used, the device can be stood on this bottom part which will allow the device to stand stably on a surface both while being filled and if the device has to be put down during the course of administering medicine from the cup. The checking section also forms a grip portion enabling the person administering the medicine to have a good firm hold of the device which makes it much easier to control than would be the case if, for example, the medicine was being administered from a teaspoon.

When the device is reversed (FIG. 2) the choking hazard checking section is uppermost. This is a hollow cylindrical tube 18 with an inclined internal floor 20, and the size of these regions is set to correspond with the dimensions of a baby's throat. To check whether an item would present a choking hazard to a baby or small child, the item is placed in the open top of the cylinder 18. If the object fits entirely within the cylinder (without compressing it), it fails, ie the object will present a choking hazard. If the diameter of the cylinder is 32 mm, the distance to the highest part of the floor is 25 mm and to the lowest part of the floor is 55 mm, then any object which first entirely within the cylinder will typically pose a choking hazard for children under 3 years of age.

As the diameter of the rim of the cup 10 is slightly larger than the diameter of the choking hazard checking section, the device will stand in a stable upright position when being used. The device is constructed with the cup, neck and choke hazard checking section all coaxial with one another.

The device should be constructed so that it can be easily washed and kept clean, and the plastics chosen for its manufacture should be selected with that in mind.

1. A babycare device comprising a medicine cup mounted on a stem, wherein the stem is constructed in the form of a gauge for checking whether an object is of a shape and size liable to cause a bay baby to choke.

2. A device as claimed in claim 1, wherein the device has a neck between the cup and the stem.

3. A device as claimed in claim 1 or claim 2, made as a single plastics moulding.

4. A device as claimed in any claim 1, wherein the walls of the device are transparent.

5. A device as claimed in claim 1, wherein graduations are applied to the walls of the medicine cup.

6. (canceled)
